(19) United States
(12) Patent Application Publication
(10) Pub. No.: US 2018/0250592 A1
(43) Pub. Date: Sep. 6, 2018

(54) VIRTUAL BASEBALL GAME SERVER AND METHOD FOR PROVIDING VIRTUAL BASEBALL GAME USING THE SAME

(71) Applicants: Keun Oh JUNG, Seoul (KR); Jae Hyuk SHIN, Seoul (KR)

(72) Inventors: Keun Oh JUNG, Seoul (KR); Jae Hyuk SHIN, Seoul (KR)

(21) Appl. No.: 15/847,915

(22) Filed: Dec. 20, 2017

(30) Foreign Application Priority Data
Mar. 3, 2017 (KR) 10-2017-0027826

(51) Int. Cl. A63F 13/46; A63F 13/812; A63F 13/35; A63F 13/795

(52) U.S. Cl. CPC A63F 13/46; A63F 13/795; A63F 13/35; A63F 13/812

(57) ABSTRACT

The present invention relates to a virtual baseball game server and a method for providing a virtual baseball game using the same. According to the server and the method, when running a virtual baseball game by receiving, from a plurality of user terminals, team configuration information and a matching method for teams selected for participating in a virtual baseball game, play records of actual players are externally received and formatted as a data table, and a virtual baseball game is sequentially run on the basis of the data table, so that a baseball game between users may be run on the basis of play records of actual players.

### CROSS-REFERENCE TO RELATED APPLICATION

This application claims priority to Korean Patent Application No. 10-2017-0027826 filed on Mar. 3, 2017 and all the benefits accruing therefrom under 35 U.S.C. § 119, the contents of which are incorporated by reference in their entirety.

### BACKGROUND

The present disclosure herein relates to a virtual baseball game server and a method for providing a virtual baseball game using the same. According to the server and the method, when running a virtual baseball game by receiving, from a plurality of user terminals, team configuration information and a matching method for teams selected for participating in a virtual baseball game, play records of actual players are externally received and formatted as a data table, and a virtual baseball game is sequentially run on the basis of the data table, so that a baseball game between users may be run on the basis of actual play records of players.

As the Internet is widely used, a large amount of network games for allowing users to play games between the users through not only conventional computers but also mobile devices as smartphones are being developed and widely used. In particular, sports such as baseball, basketball, and football are popular among many people, and games of such sports are receiving a lot of attention.

With this trend, developers are providing various types of sports games to users. Such sports games representatively include a fantasy sports game genre in which a user selects players to participate in a sports game and a virtual match is played between teams of players selected on the basis of actual play data.

A fantasy sports game represents a game in which user's preferred players may be grouped as a team regardless of their clubs and play records of actual players may be received to play a match. This allows a user to play a role as a coach so that a more realistic sports game may be played. Due to this advantage, fantasy sports games are receiving more attention in comparison with other types of sports games.

According to a conventional fantasy sports game, points corresponding to actual play records of players selected by a user are calculated, and victory/defeat and ranking are determined by comparing the sums of calculated points between matched users. For example, actual play records of baseball players selected by a user are externally received, and 0 point is given for out or strikeout, 3 points are given for a base on balls or hit, and 12 points are given for home run to add up the points. However, in the case of a conventional point calculating system for determining victory/defeat and ranking of a game, the rules and characteristics of a corresponding sport are not reflected, and thus the association with the corresponding sport is decreased, causing a user to lose interest in a baseball game. For example, if matched users select the same players, the same points are simply calculated regardless of the rules of a corresponding sport, resulting in a tie. Furthermore, the conventional system brings about an ironic result in which a player who made a single hit after multiple turns at bat in an actual baseball game obtains the same point as that of a player who took a turn at bat only once as a pinch hitter and made a hit. Therefore, it is necessary to develop a game that can be played more realistically and arouse interest in tactics in comparison with a conventional fantasy sports game in which points are calculated simply based on the actual play records of players.

### SUMMARY

The present disclosure provides a virtual baseball game server and a method for providing a virtual baseball game using the same, according to which, when running a virtual baseball game by receiving, from a plurality of user terminals, team configuration information and a matching method for teams selected for participating in a virtual baseball game, play records of actual players are externally received and formatted as a data table, and a virtual baseball game is sequentially run on the basis of the data table, so that a baseball game between users may be run on the basis of play records of actual players.

The present disclosure also provides a virtual baseball game server and a method for providing a virtual baseball game using the same, according to which scores of a virtual baseball game are calculated by sequentially running the virtual baseball game according to a preset baseball rule on the basis of a data table including at-bat information instead of determining victory/defeat and rankings by simply adding points corresponding to at-bat information of actual players, so that a more realistic and tactical baseball game may be played.

In accordance with an exemplary embodiment of the present invention, a virtual baseball game server includes: a communication unit capable of communicating with an external device and configured to receive, from a user terminal of each of a plurality of users, team configuration information about teams selected to participate in a virtual baseball game; a storage unit configured to store, in a data table format, play records of at least one player respectively included in the selected teams on the basis of play records externally received via the communication unit or received via an input device; a matching unit configured to match at least two users among the plurality of users; and a determination unit configured to calculate scores by sequentially running, according to data included in the data table and a preset rule, the virtual baseball game between the matched users on the basis of the data table, and derive victory/defeat and ranking results of the matched users by comparing the calculated scores.

In accordance with another exemplary embodiment of the present invention, a method for providing a virtual baseball game by a virtual baseball game server includes: receiving, from a user terminal of each of a plurality of users, team configuration information about teams selected to participate in a virtual baseball game; externally receiving play records of baseball games; formatting, as a data table, play records of at least one player respectively included in the selected teams on the basis of the received play records; matching at least two users among the plurality of users by the virtual baseball game; and calculating scores by sequentially running, according to data included in the data table and a preset rule, the virtual baseball game between the matched users on the basis of the data table, and deriving victory/defeat and ranking results of the matched users by comparing the calculated scores.

### BRIEF DESCRIPTION OF THE DRAWINGS

FIG. 1 is a diagram schematically illustrating a virtual baseball game server according to an embodiment of the present invention;

FIG. 2 is a diagram illustrating a form of a data table to which play records externally received by a virtual baseball game server is converted according to an embodiment of the present invention;

FIGS. 3 and 4 are diagrams illustrating that a virtual baseball game is sequentially run by a virtual baseball game server according to an embodiment of the present invention;

FIG. 5 is a diagram illustrating a process of calculating scores by a virtual baseball game server according to an embodiment of the present invention;

FIG. 6 is a diagram illustrating a process of deriving victory/defeat and ranking results on the basis of calculated scores in a virtual baseball game server according to an embodiment of the present invention;

FIG. 7 is a diagram illustrating a manner in which players are selected by a user in a virtual baseball game server according to an embodiment of the present invention;

FIG. 8 is a flowchart schematically illustrating a virtual baseball game providing method according to an embodiment of the present invention; and

FIG. 9 is a flowchart illustrating in detail a virtual baseball game providing method according to an embodiment of the present invention.

### DETAILED DESCRIPTION OF EMBODIMENTS

The present invention is described in detail below with reference to the accompanying drawings. Herein, known functions and configurations are not described in detail in order not to unnecessarily obscure the concept of the present invention. Rather, embodiments of the present invention are provided so that this disclosure will be thorough and complete, and will fully convey the scope of the present invention to those skilled in the art. In the drawings, shapes and sizes of elements may be exaggerated for clarity of illustration.

When it is mentioned that a certain part “includes” or “comprises” certain elements, the part may further include other elements, unless otherwise specified.

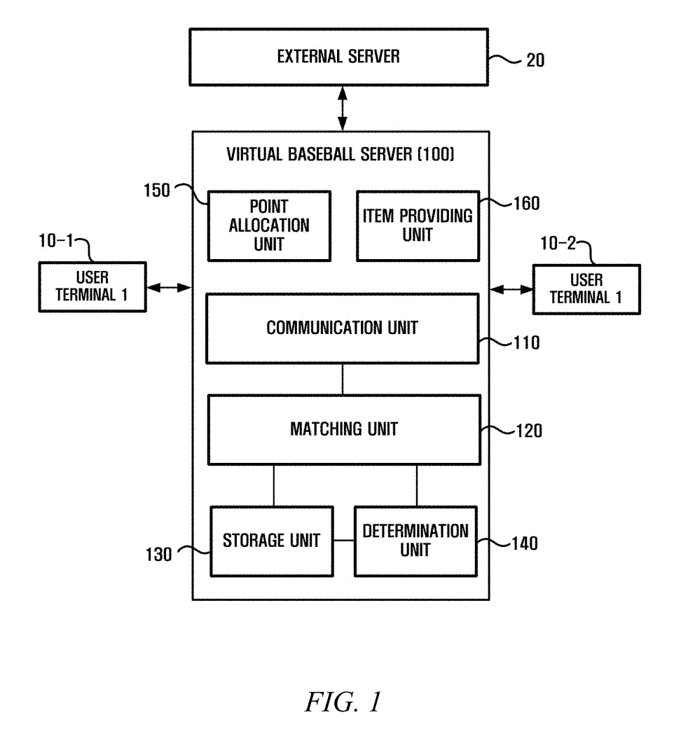

The term “ . . . unit” denotes a unit for processing at least one function or operation, and may be implemented as hardware or software or a combination thereof. FIG. 1 is a diagram schematically illustrating a virtual baseball game server according to an embodiment of the present invention.

FIG. 1 is a diagram schematically illustrating a virtual baseball game server according to an embodiment of the present invention.

Referring to FIG. 1, a virtual baseball game server 100 according to an embodiment of the present invention may include a communication unit 110, a matching unit 120, a storage unit 130, and a determination unit 140.

The virtual baseball game server 100 illustrated in FIG. 1 is based on an embodiment of the present invention, and the elements of the virtual baseball game server 100 is not limited to the embodiment illustrated in FIG. 1, and thus the elements may be modified or removed or other elements may be added as necessary. For example, the communication unit 110, the matching unit 120, the storage unit 130, and the determination unit 140 may be configured as a single element.

In another embodiment, the matching unit 120, the determination unit 140, the point allocation unit 150 and the item providing unit 160 may be configured as a control unit. The control unit can include at least one processor. The control unit, in some embodiments, includes one or more physical, actual storage devices. Examples of physical, actual storage devices include, but are not limited to, magnetic media such as, a hard disk, a floppy disk, and a magnetic tape, optical media such as a CD-ROM and a DVD, magneto-optical media such as a floppy disk, and a hardware device configured especially to store and execute a program, such as a ROM, a RAM, a solid state drive, and a flash memory. The control unit is implemented, in some embodiments, by one or more programmed processors and/or application-specific integrated circuits (ASICs).

The communication unit 110 may receive, from a user terminal of each of a plurality of users, team configuration information about team selected to participate in a virtual baseball game. Here, the team configuration information may be information of a team required for running the virtual baseball game. For example, the team configuration information about team may include at least one of the number of players, positions of the players, names of the players, clubs to which the players belong, or a batting order. The virtual baseball game server 100 may run the virtual baseball game on the basis of the received team configuration information about team.

The communication unit 110 can support communications according to diverse communication specifications including but not limited to network module, RF module, 3G and LTE (Long Term Evolution), Wi-Fi, and Bluetooth and it can support diverse wireless/wired communication modes.

The communication unit 110 may externally receive play records of baseball games. Here, the play records may be play contents of actual players required for the virtual baseball game server 100 to run the virtual baseball game. For example, the communication unit 120 may receive, as the play records of baseball games, data including baseball play records from a database provided by the Korean Baseball Organization (KBO) or Major League Baseball (MLB). According to an embodiment, the play records may include at-bat information including at least one of a hit, a two-base hit, a three-base hit, a home run, a base on balls, a hit by pitch, an intentional base on balls, a strikeout, a double play, a triple play, a fly out, a sacrifice bunt, or a batting interference. Here, in the case where the at-bat information may be one of a hit, a two-base hit, a three-base hit, a hit by pitch, a base on balls, an intentional base on balls, or a batting interference, the play records may further include base-running information including at least one of stolen base, caught stealing, a pickoff, or an out on base.

The play records received by the communication unit 110 may be formatted as a data table in the storage unit 130 described below, in order to run the virtual baseball game.

The matching unit 120 may match at least two users among the plurality of users. To this end, the communication unit 110 may receive a matching method from a user terminal 10 of each of the plurality of users. The matching unit 120 may match at least two of the plurality of users on the basis of the received matching method.

Here, the matching method may be a method by which a user participating in the virtual baseball game selects a game method preferred by the user. For example, the matching method may be an individual event in which two users among a plurality of users are one-to-one matched or a team event in which three or more users are matched to play a game in a many-to-one, many-to-many, round-robin tournament, or single-elimination tournament manner. A user may select the individual event or the team event according to a preference of the user via the user terminal 10 of the user. Furthermore, in the team event, the user may select a many-to-one manner in which one user is matched to multiple users, a many-to-many manner in which a team of multiples users is matched to another team of multiple users, a round-robin tournament manner in which a plurality of users are grouped together and are matched each other on a regular schedule during a certain period, or a single-elimination tournament manner in which a plurality of users are grouped together and two users are matched for each round to determine a final win.

The communication unit 110 may receive a selected matching method from the user terminal 10. The matching unit 120 may match, on the basis of the matching method received through the communication unit 110, two users among a plurality of users who have selected the individual event, so as to run the virtual baseball game. Furthermore, the matching unit 120 may group three or more users among a plurality of users who have selected the team event, so as to run the virtual baseball game.

In another embodiment, the matching unit 130 may receive, in addition to the matching method, a scale value of many-to-one, many-to-many, round-robin tournament, and single-elimination tournament via the user terminal 10, and may generate a round-robin tournament or single-elimination tournament group of a received scale to allocate a plurality of users thereto. For example, when a user selects a single-elimination tournament team event as the matching method and inputs the scale value of 16, the user may be allocated to a group in which two of 16 users are matched for each round to proceed with a single-elimination tournament.

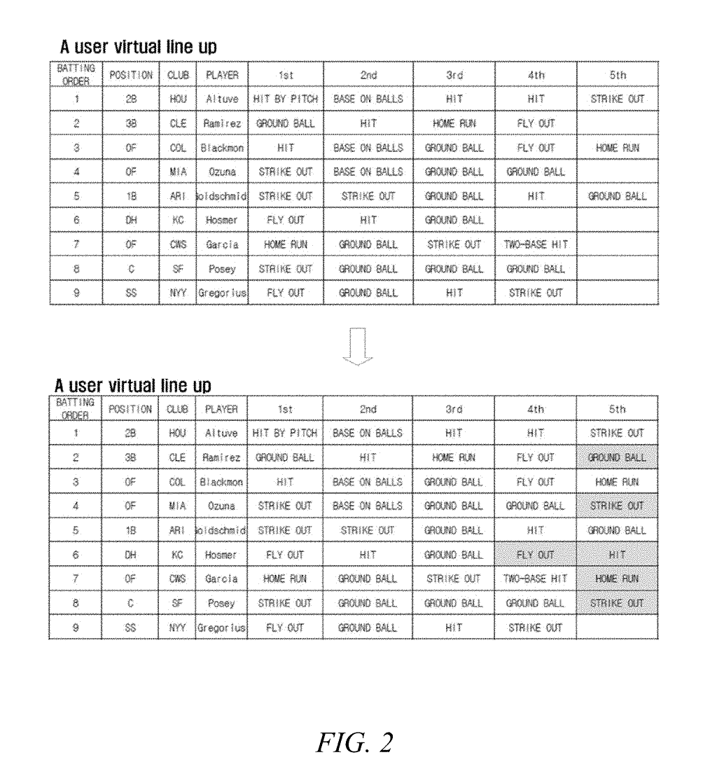

The storage unit 130 may format, as a data table, play records of at least one player included in each team selected by matched users on the basis of the play records externally received via the communication unit 110. The storage unit 130 may store the play records in the format of a data table. The storage unit 130 may include at least one of memory, cash and buffer. The storage unit 130 can be configured software (e.g., Database), firmware, hardware (e.g., RAM) or a combination at least two of software, firmware and hardware. An embodiment in which externally received play records are formatted as a data table is described below with reference to FIG. 2.

FIG. 2 is a diagram illustrating a form of a data table to which play records externally received by a virtual baseball game server is converted according to an embodiment of the present invention.

Referring to FIG. 2, the virtual baseball game server 100 may externally receive play records of at least one player included in a team selected by a user, among actual players.

Provided that the number of players to be allocated to a virtual baseball game is M, and a preset maximum number of data per player is N, the storage unit 130 may create a data table in the format of a M×N matrix, and may store the externally received play records in the data table. For example, as illustrated in FIG. 2, M may be 9, and N may be 5 or 6. In this case, the storage unit 130 may receive and store actual play records of up to 5 at-bats or 6 at-bats of players selected by a user. Here, N is not a fixed number, and may be changed according to the number of data per player required for playing a baseball game.

In an embodiment, the virtual baseball game server 100 may calculate the number of data required for recording 27 outs according to a preset rule, and may set this number as the maximum data number N. For example, if nine players require five data to record 27 outs, the virtual baseball game server 100 may set N to 5. In the case where matched players obtain the same score as a result of playing until a 9th inning according to a preset rule in the determination unit 140 described below, the virtual baseball game server 100 may change a value of N in order to derive an outcome of a game and a ranking result. For example, when the number of data required for playing additional one inning is 1, the virtual baseball game server 100 may change the maximum data number to 6.

In another embodiment, the maximum data number may be a value set by a producer of the virtual baseball game server 100 in order to derive a game result when running a baseball game by the virtual baseball game server 100. For example, when the maximum data number per player required for running a virtual baseball game until a 9th inning is 4, the producer may set the maximum data number to 4 to run the virtual baseball game until the 9th inning, or may set the maximum data number to 5 or 6 to run the virtual baseball game until a 12th inning or more.

The storage unit 130 may store at-bat information of an actual player included in the play records, in a row of the data table corresponding to an order of the player. Here, the players selected by a user may be replaced during an actual sports game, and thus the number of pieces of the at-bat information of the selected players may not reach the number of data per player required for deriving a game result. Therefore, when the number of pieces of the at-bat information is smaller than the number of data per player for deriving a game result, the virtual baseball game server 100 according to an embodiment of the present invention may repeatedly input and store the at-bat information by as much as the number of data per player. For example, Ramirez, who is a second batter, has only 2 recorded out, 1 hit and 1 homerun in an actual game, and has only recorded 4 at bats which do not reach 5 which is the number of data for deriving a game result. In this case, the storage unit 130 may input and store ground ball, 5 at bats.

In another embodiment, in the case where a player has not participated in an actual sports game, and thus play records cannot be received, the storage unit 130 may set the records of the player as out, and may repeatedly input and store the record of out by as much as the number of data required for deriving a game result.

In another embodiment, the virtual baseball game server 100 according to an embodiment of the present invention may store, in a data table, only at-bat information and base-running information of players obtained at actual games, and may repeatedly input and apply the at-bat information obtained at actual games whenever the at-bat information is insufficient while running a baseball game.

In another embodiment, a manager of the virtual baseball game server 100 according to an embodiment of the present invention may directly input play records via a manager terminal, and the storage unit 130 may store the input play records in a data table.

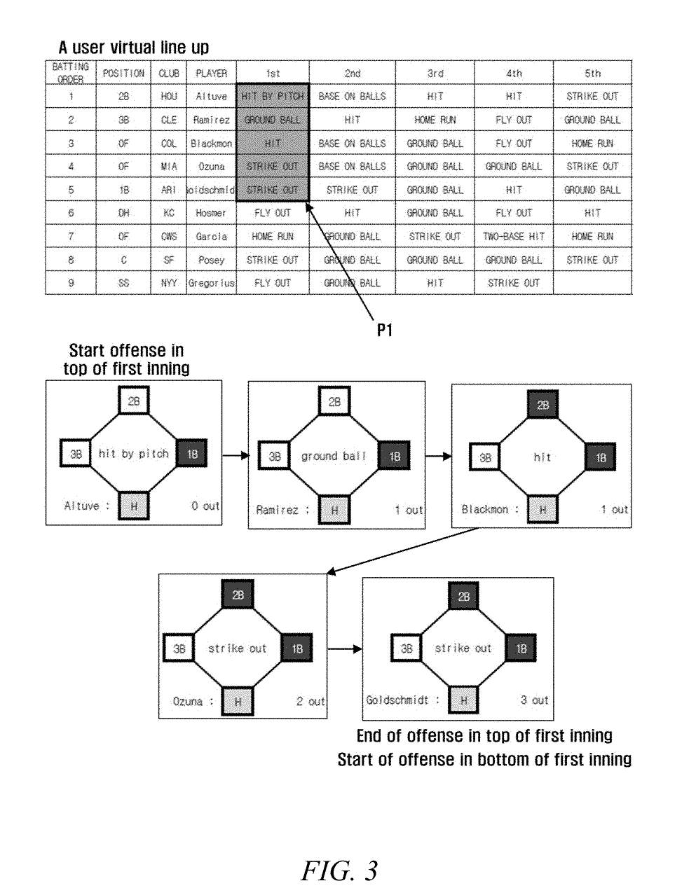

Referring back to FIG. 1, the determination unit 140 may calculate scores by sequentially running, on the basis of data included in the data table and a preset rule, virtual baseball games between users matched on the basis of the data table stored in the storage unit 130. Furthermore, the determination unit 140 may derive victory/defeat and ranking results of the matched users by comparing the calculated scores. Described below with reference to FIGS. 3 to 6 are an embodiment of an manner of sequentially running a virtual baseball game and an embodiment of a manner of deriving victory/defeat and ranking results by comparing scores.

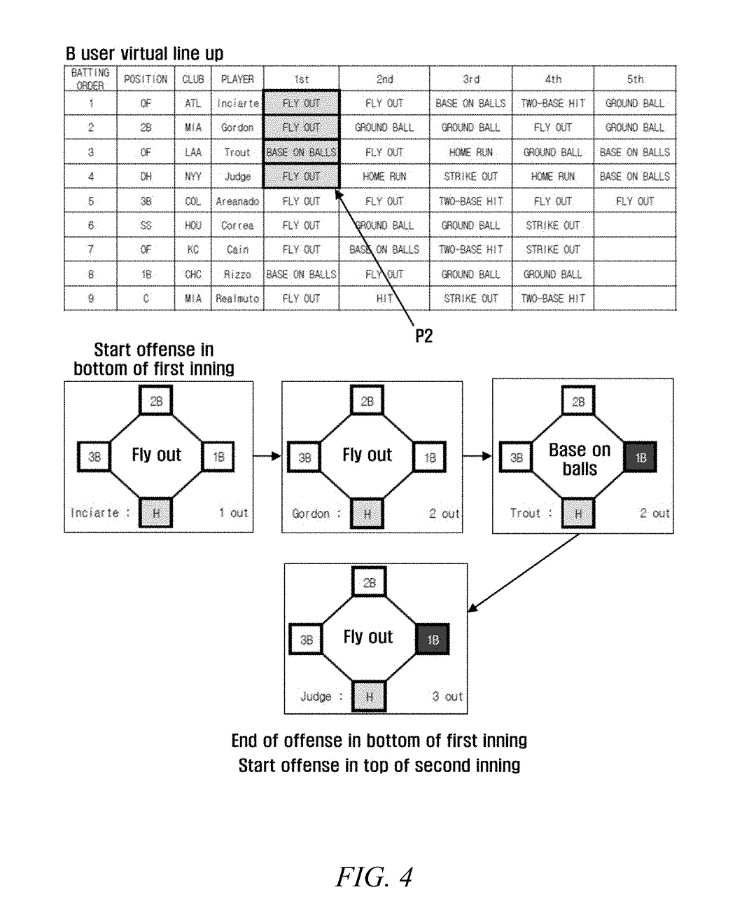

FIGS. 3 and 4 are diagrams illustrating that a virtual baseball game is sequentially run by a virtual baseball game server according to an embodiment of the present invention.

Referring to FIGS. 3 and 4, the determination unit 140 may sequentially run a virtual baseball game according to a preset rule and data tables corresponding to players respectively selected by user A and user B matched through the matching unit 120. Here, the preset rule is a rule set by the producer of the virtual baseball game server 100 to run a virtual baseball game normally by excluding variables of an actual game on the basis of baseball rules.

In an embodiment, the preset rule may be a rule determined by the KBO or MLB to play an actual baseball game. For example, baseball may be ended in the ninth inning, and batting and fielding teams may be switched when three outs are recorded. Furthermore, when a victory/defeat is not determined until the ninth inning, an extra inning game may be played until victory/defeat is determined or an upper limit of extra innings (e.g., 12th inning) may be set to play an extra inning game. In another embodiment, the preset rule may be a rule obtained by adding a rule arbitrarily set by the producer to the rule determined by the KBO or MLB to play an actual baseball game. For example, although an actual player has recorded base stealing after a hit in an actual game, the player may be unable to steal a base due to a preceding runner in a baseball game provided by the virtual baseball game server 100 according to an embodiment of the present invention. In this case, the base-running information may be set as optional information depending on a situation, and when a game situation conflicts with the base-running information, only at-bat information may be applied without applying the base-running information so as to prevent confliction between pieces of information during a base ball game. When the user A is selected as a first batter according to a preset method, the determination unit 140 may sequentially make a progress starting with a first column of the data table corresponding to the user A according to the at-bat information included in the columns of the data table. Here, the preset method may be arbitrarily selected using a random function. As illustrated in FIG. 3, the determination unit 140 may designate columns as at-bats starting with a first at-bat in the data table of the user A, and may make a progress starting with a first batter according to a batting order. As the progress is sequentially made starting with the first column, three outs (one ground ball, two strikeouts) are input from first to fifth batters of the user A, and the determination unit 140 may hand over an offense right to the user B according to baseball rules.

As illustrated in FIG. 4, In the same manner as that for the user A, the determination unit 140 may make a progress starting with a first column of the data table corresponding to the user B according to the at-bat information included in the columns of the data table. The determination unit 140 may designate columns as at-bats starting with a first at-bat in the data table of the user B, and may make a progress starting with a first batter according to a batting order. In the case of the user B, three outs (three flies) are input from first to fourth batters, and the determination unit 140 may hand over an offense right to the user A according to baseball rules. Here, in the virtual baseball game server 100 according to an embodiment of the present invention, the determination unit 140 may designate lastly input at-bat information in the data tables of the user A and user B using a point function, and may sequentially execute data following the designated data in the data table in the case of receiving an offense right back. For example, in the case where three outs (one ground ball, two strikeouts) are input from first to fifth batters of the user A, the determination unit 140 may designate and store the data of the data table in which the third out is input, using a pointer P1. Furthermore, in the case where three outs are input from first to fourth batters of the user B, the determination unit 140 may designate and store the data of the data table in which the third out is input, using a pointer P2. Thereafter, when an offence right is handed over to user A again, the determination unit 140 may sequentially execute data following the data of the data table designated by the pointer P1. When three outs are input again, the determination unit 140 may update, with the pointer P1, the data of the data table in which the third out is input.

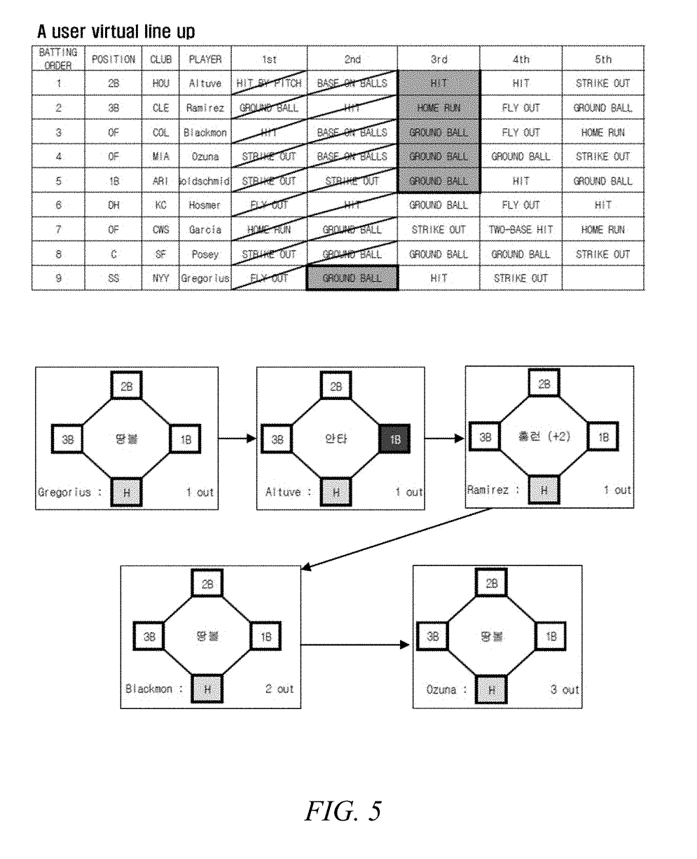

FIG. 5 is a diagram illustrating a process of calculating scores by a virtual baseball game server according to an embodiment of the present invention.

Referring to FIG. 5, when making a hit and a two-base hit, players may advance to bases according to actual baseball rule, and the determination unit 140 may accordingly calculate a score. Every time a column of the data table of a user on offense is ended, the determination unit 140 may proceed with a next column. For example, when the number of outs is 2 or less even after the records of the ninth batter of the second column are input, the determination unit 140 may proceed with a second at-bat of the first batter of the next column, i.e., the third column, to input play records.

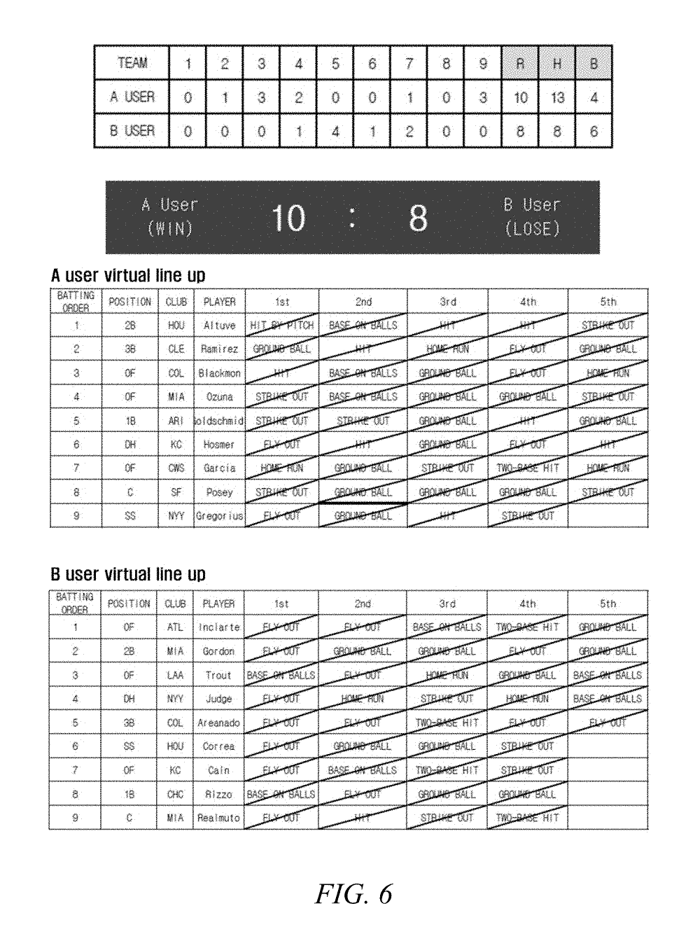

FIG. 6 is a diagram illustrating a process of deriving victory/defeat and ranking results on the basis of calculated scores in a virtual baseball game server according to an embodiment of the present invention.

Referring to FIG. 6, the determination unit 140 may compare finally calculated scores when the offenses of the user A and the user B are completed at the ninth inning. The determination unit 140 may compare the calculated scores to determine a user who has recorded a higher score as a winning team. Here, if the calculated scores are equal to each other, the determination unit 140 may run an additional game through an extra inning game in the same manner as actual baseball, wherein the range of the extra inning game may be preset to a specific value. For example, the determination unit 140 may additionally run a game until a 12th inning or more. However, in the case where the calculated points of matched users are equal to each other even though the additional game has been run, the user who has used less points allocated by a point allocation unit 150 described below may be determined to be a winning team, or the game may be determined to be a tie if the calculated scores and the amounts of used allocated points are equal.

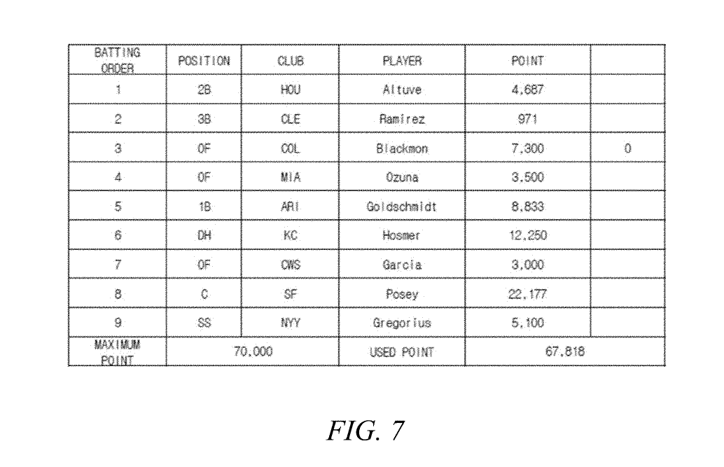

Referring back to FIG. 1, the virtual baseball game server 100 according to an embodiment of the present invention may further include the point allocation unit 150. An example in which players are selected within allocated points is described below with reference to FIG. 7.

FIG. 7 is a diagram illustrating a manner in which players are selected by a user in a virtual baseball game server according to an embodiment of the present invention.

Referring to FIG. 7, the point allocation unit 150 may allocate points to each of a plurality of users.

Here, the points may be used by a user when the user selects a desired team and players belonging thereto through the user terminal 10. The user may select preferred players in order to participate in the virtual baseball game. When players are selected through the user terminal 10, points corresponding to the players may be subtracted from allocated points. For example, in the case where 70,000 points are allocated to the user, and the points corresponding to the selected players are 7,300 points, remaining points for the user may be 62,700 points.

In another embodiment, the point allocation unit 150 may allocate equal points to each of a plurality of users.

The plurality of users may select players so that a sum of points preset for each players is equal to or smaller than points allocated by the point allocation unit 150, and the communication unit 110 may receive team configuration information of a team including the players selected so that the sum of the points of the players is equal to or smaller than the allocated points.

Referring back to FIG. 1, the virtual baseball game server 100 according to an embodiment of the present invention may further include an item providing unit 160.

The item providing unit 160 may provide items to a plurality of users participating in the virtual baseball game through the virtual baseball game server 100. Here, the item may be an element which is used in the virtual baseball game server 100 to give a certain effect to a user. For example, the item may include at least one of a point increasing item for increasing points allocated to a user or a record applying item for applying a play record desired by a user at bat of a designated batting order.

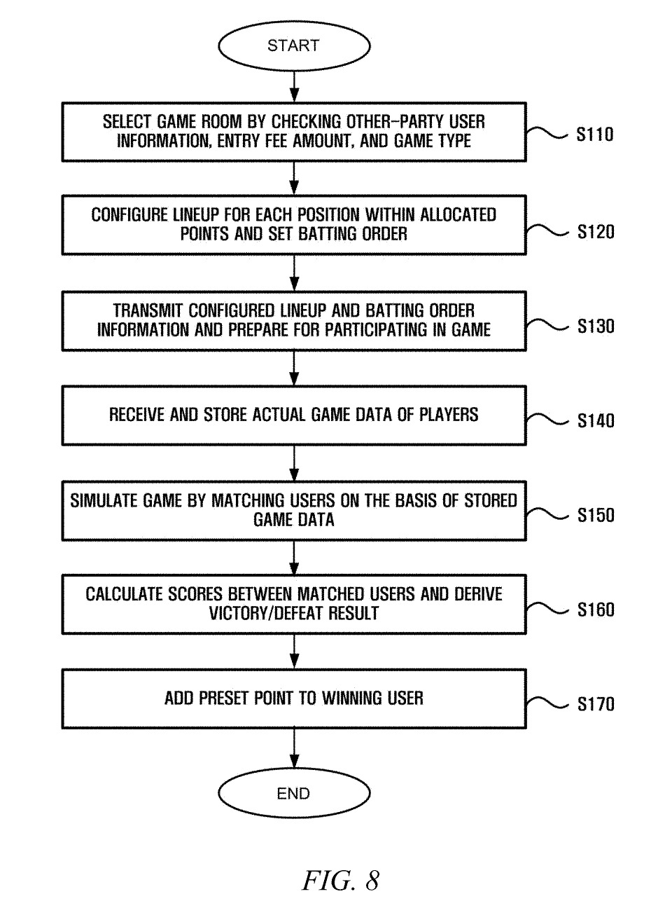

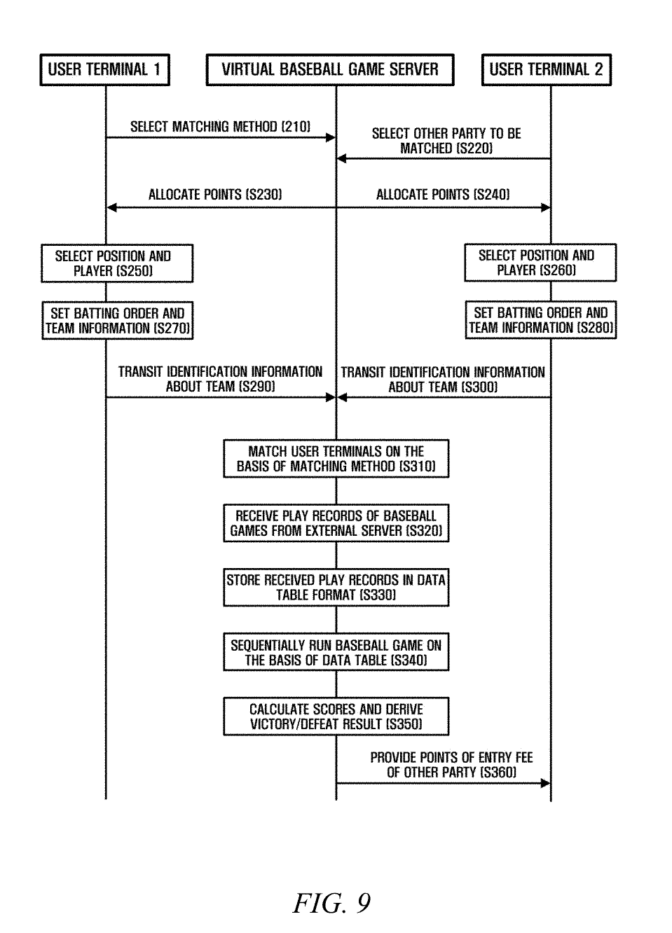

In an embodiment, the point allocation unit 150 may allocate, to a user, item points for purchasing and selling items, apart from the points allocated for selecting players. A virtual baseball game providing method according to an embodiment of the present invention is described below with reference to FIGS. 8 and 9.

FIG. 8 is a flowchart schematically illustrating a virtual baseball game providing method according to an embodiment of the present invention.

Referring to FIG. 8, a virtual baseball game providing method (S100) according to an embodiment of the present invention may include: generating or selecting a game room by checking other-party user information, an entry fee amount, an award method, a game type, and a matching method (S110); configuring a lineup within allocated points and setting a batting order (S120); preparing for participating in a game by transmitting a configured lineup and batting order information and paying an entry fee (S130); receiving and storing actual play data of players (S140); simulating a game according to a preset rule by matching users on the basis of stored play data (S150); calculating scores between the matched users and deriving victory/defeat and ranking results (S160); and adding preset prize money to a winning user (S170).

A virtual baseball game providing method according to an embodiment of the present invention is described in more detail below with reference to FIG. 9.

FIG. 9 is a flowchart illustrating in detail a virtual baseball game providing method according to an embodiment of the present invention.

Referring to FIG. 9, when a user terminal sets at least one matching method among an individual event in which two users are one-to-one matched and a team event in which users are matched in a many-to-one, many-to-many, round-robin tournament, or single-elimination tournament manner and a matching method such as an entry fee amount and an award method (S210), the virtual baseball game providing method (S100) according to an embodiment of the present invention is initiated, and a virtual baseball game server matches at least two users among a plurality of users on the basis of set matching methods. When a plurality of users choose to match on the basis of matching methods in operations S210 and S220, the virtual baseball game server allocates points to a plurality of user terminals (S230 and S240). In operations S230 and S240, the points are equally provided to the plurality of user terminals, but more points are provided to a user who has used the point increasing item for increasing allocated points. The users may select preferred players (S250 and S260) within the points allocated in operations S230 and S240, and may set team information including batting orders of the selected players (S270 and S280).

The players and team information selected in operations S250 to S280 may be transmitted as team configuration information about team to the virtual baseball game server (S290 and S300). The virtual baseball game server may match at least two users among a plurality of users (S310) on the basis of the matching method selected in operation S210 and the team information transmitted in operations S290 and S300. Once a plurality of users are matched on the basis of the matching method in operation S310, the virtual baseball game server externally receives play records of actual baseball games (S320). In another embodiment, the play records of actual baseball games may be values received through an additional input device. The play records received in operation S320 are formatted as a data table so as to be stored in a storage unit (S330), and a baseball game between the matched users is sequentially run on the basis of the stored data table (S340). In operation S340, when the baseball game is sequentially run on the basis of the data table, an at-bat result may be adjusted by using the record applying item for applying a play record desired by a user at bat of a designated batting order. When the baseball game run in operation S340 is ended, a determination unit finally calculates scores to derive victory/defeat and ranking results (S350). When equal scores are recorded even though the baseball game is played until a ninth inning in operation S350, an extra inning game is played until up to 12th inning or more. When equal scores are recorded even after the extra inning game is played, a user who has used less allocated points is determined to be winning team. If the allocated points are equal, the game is determined to be a tie. The user determined to be a winning team in operation S350 is provided with entry fee points paid by the other-party user (S360).

The above-mentioned virtual baseball game providing method has been described with reference to the flowcharts illustrated in the drawings. Although the method is illustrated as a series of blocks to give simple descriptions, the present invention is not limited to the sequence of the blocks, and thus some blocks may occur in an order different from the order illustrated and described in this specification or may occur concurrently with the other blocks, and various other branches, flow paths, and orders of blocks for achieving the same or similar result may be implemented. Furthermore, all of the illustrated blocks may not be required for implementing the method described herein.

Although the virtual baseball game server and the method for providing a virtual baseball game using the same have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. A virtual baseball game server comprising:
a communication unit capable of communicating with an external device and configured to receive, from a user terminal of each of a plurality of users, team configuration information about teams selected to participate in a virtual baseball game;
a storage unit configured to store, in a data table format, play records of at least one player respectively included in the selected teams on the basis of play records externally received via the communication unit or received via an input device;
a matching unit configured to match at least two users among the plurality of users; and
a determination unit configured to calculate scores by sequentially running, according to data included in the data table and a preset rule, the virtual baseball game between the matched users on the basis of the data table, and derive victory/defeat and ranking results of the matched users by comparing the calculated scores.

2. The virtual baseball game server of claim 1, wherein the storage unit stores the data table as an M×N matrix where M denotes number of players to be allocated to the virtual baseball game and N denotes number of data per player for deriving the results, and the storage unit stores at-bat information of an actual player included in the play records in a row of the data table corresponding to an order of the actual player, and, when number of pieces of the at-bat information is smaller than the number of data per player for deriving the results, repeatedly inputs and stores the at-bat information by as much as the number of data per player for deriving the results.

3. The virtual baseball game server of claim 1, further comprising:
a point allocation unit configured to allocate points to each of the plurality of users,
wherein the communication unit receives an input of selection of the at least one player from each user terminal so that a sum of points preset for each selected player is equal to or smaller than the allocated points,
wherein the team configuration information about the selected teams comprises information about the selected player.

4. The virtual baseball game server of claim 3, wherein the determination unit runs an extra inning game when the calculated scores between the matched users are equal, and determines, as a winning team, a user who has recorded more additional scores through the extra inning game, and, when the calculated scores are equal after the extra inning game, the determination unit determines, as the winning team, a user who has less used the allocated points or determines a tie when the calculated scores and the amounts of used allocated points are equal.

5. The virtual baseball game server of claim 3, further comprising:
an item providing unit configured to provide an item to the plurality of users,
wherein the item comprises at least one of a point increasing item for increasing the allocated points or a record applying item for applying a play record desired by a user at bat of a designated batting order.

6. A method for providing a virtual baseball game by a virtual baseball game server, the method comprising:
receiving, from a user terminal of each of a plurality of users, team configuration information about teams selected to participate in a virtual baseball game;
externally receiving play records of baseball games;
formatting, as a data table, play records of at least one player respectively included in the selected teams on the basis of the received play records;
matching at least two users among the plurality of users by the virtual baseball game; and
calculating scores by sequentially running, according to data included in the data table and a preset rule, the virtual baseball game between the matched users on the basis of the data table, and deriving victory/defeat and ranking results of the matched users by comparing the calculated scores.

7. The method of claim 6, wherein the formatting as the data table comprises:
forming the data table as an M×N matrix where M denotes number of players to be allocated to the virtual baseball game and N denotes number of data per player for deriving the results;
storing at-bat information of an actual player included in the play records in a row of the data table corresponding to an order of the actual player; and
repeatedly inputting and storing the at-bat information by as much as the number of data per player for deriving the results when number of pieces of the at-bat information is smaller than the number of data per player for deriving the results.

8. The method of claim 7,
wherein the at-bat information is one of a hit, a two-base hit, a three-base hit, a home run, a base on balls, a hit by pitch, an intentional base on balls, a strikeout, a double play, a triple play, a fly out, a sacrifice bunt, or a batting interference,
wherein, when the at-bat information is one of the hit, the two-base hit, the three-base hit, the base on balls, the hit by pitch, the intentional base on balls, or the batting interference, the play records further comprise base-running information comprising at least one of a stolen base, caught stealing, a pickoff, or an out on base,
wherein the formatting as the data table comprises generating a first data table for a team selected by a first user terminal among user terminals of the plurality of users and a second data table for a team selected by a second user terminal among the user terminals of the plurality of users,
wherein the deriving the victory/defeat and ranking results comprises:
making a progress starting with a first column according to the at-bat information included in columns of the first data table corresponding to one of the matched users;
proceeding with a next column every time a column of the data table is ended; and
handing over a turn to the second data table when three outs of the at-bat information are recorded.

9. The method of claim 6, wherein selecting the teams comprises:
allocating points to each of the plurality of users by the virtual baseball game server; and
selecting the players so that a sum of points preset for each player selected by each user terminal is equal to or smaller than the allocated points,
wherein the matching comprises:
receiving an input of selection of one of matching methods comprising at least one of an individual event in which two users among the plurality of users are one-to-one matched or a team event in which three or more users are matched in a many-to-one, many-to-many, round-robin tournament, or single-elimination tournament manner; and
matching the plurality of user on the basis of the matching methods.

10. The method of claim 9, wherein the deriving the victory/defeat and ranking results comprises:
running an extra inning game when the calculated scores between the matched users are equal;
determining, as a winning team, a user who has recorded more additional scores through the extra inning game;
determining, as the winning team, a user who has less used the allocated points when the calculated scores are equal after the extra inning game; and
determining a tie when the calculated scores and the amounts of used allocated points are equal.
